(19) United States
(12) Patent Application Publication
(10) Pub. No.: US 2016/0182289 A1
(43) Pub. Date: Jun. 23, 2016

(54) SYSTEM AND METHOD FOR DEVICE PAIRING TRANSACTION

(71) Applicant: Interactive Intelligence Group, Inc., Indianapolis, IN (US)

(72) Inventors: Brian Kamrowski, Amherst, NY (US); Felix Immanuel Wyss, Zionsville, IN (US)

(21) Appl. No.: 14/975,458

(22) Filed: Dec. 18, 2015

Related U.S. Application Data
(60) Provisional application No. 62/093,854, filed on Dec. 18, 2014.

(51) Int. Cl. H04L 12/24; H04L 29/06; H04L 29/08

(52) U.S. Cl. CPC H04L 41/0806; H04L 67/141; H04L 67/34; H04L 63/10

(57) ABSTRACT

A provisioning mechanism that may be used when a device is distributed to a third party over an untrusted distribution channel. The provisioning mechanism allows a server to recognize and trust the remote device. For example, a device may need to be paired to web services hosted in the cloud. The device, which has been delivered to a customer, may be on-premises, such as at a customer site or a data center. In order to avoid use by an unauthorized party, the device may have been shipped in an un-provisioned state. As a result, the customer will have to sync (or pair) the device to the cloud products hosted in the cloud in order to have full functionality. In an embodiment, the process for device pairing may only need to be completed once, upon initial start-up of the device.

### CROSS REFERENCE TO RELATED APPLICATION

This application claims the benefit of and incorporates by reference herein the disclosure of U.S. Ser. No. 62/093,854, filed Dec. 18, 2014.

### BACKGROUND

The present invention generally relates to telecommunications systems and methods. More particularly, the present invention pertains to a system and method for pairing a remote device connected over a telecommunications system to a cloud computing environment.

When a device to be used with services hosted in a cloud computing environment is shipped to an end user, the device may be shipped in an un-provisioned state and may be located at a customer site or a data center. The device may have been shipped in an un-provisioned state to avoid use by an unauthorized party. Consequently, the device is in an unpaired state when it reaches the consumer. As a result, the consumer has to sync (alternately referred to as “pair”) the device to cloud products hosted in the cloud to have full functionality.

### SUMMARY

A system and method are presented for pairing a remote device to a cloud computing environment over a telecommunications network.

In one embodiment, a method for syncing a device to cloud hosted services is disclosed, the method comprising the steps of: initiating the pairing process, comprising the steps of: powering-on the device, wherein the device automatically starts the pairing process; and generating a unique ID using a salt file and manufacture data; establishing a connection between the device and a pairing manager located in the cloud; establishing credentials of the device, comprising sending the unique ID to the cloud, where a check is performed for a match. If there is no match, the transaction terminated and a security alert generated. If there is a match, verify that the device has not been paired before. If it has, terminate request and send security alert. Change a state of the device from pairing to run-time with successful completion.

Other embodiments are also disclosed.

### BRIEF DESCRIPTION OF THE DRAWINGS

FIG. 1 is a diagram illustrating a system for device pairing.

FIG. 2 is a flowchart illustrating a process for device pairing.

FIGS. 3A-B comprise a sequence diagram illustrating a process for device pairing.

FIGS. 4A-B comprise a sequence diagram illustrating a process for device pairing.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

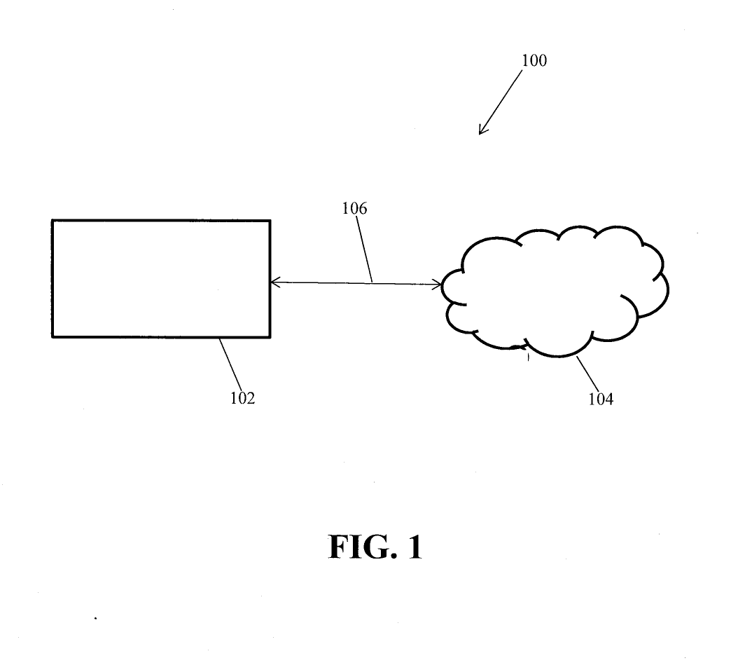

FIG. 1 is a diagram illustrating a system for device pairing, indicated generally at 100. The device 102 may comprise a multipurpose product which manages a plurality of aspects of SIP processing for contact center automation and for unified communications in the enterprise, such as Interactive Intelligence's Interaction Edge® device. The device 102 may be preconfigured with information needed for the syncing, or pairing, of the device with the web services hosted in cloud computing environment 104 coupled to the device 102 over a telecommunications website 106. For example, a Customer Signature Request (CSR) may install the prerequisite pairing data when the device 102 is manufactured. The CRS may execute an application which generates a salt file, which is persisted on an internal drive of the device 102. The device's unique identifier may be generated based on the unique values of the hardware and the salt file on the internal drive. In an embodiment, the unique values may include equipment serial numbers, CPUID, MAC, etc.

The salt is written to a file when the unique identifier is generated. If the salt file changes, the unique identifier also changes. If the salt remains the same, the unique identifier remains the same when generated on the same device 102. If the same salt is used with two different devices 102, the unique identifier generated by each device 102 will be different. As such, multiple virtual machines (VMs) can operate as a device 102 on the same physical hardware as each VM will have its own salt and its own hardware identifier.

The version of the unique identifier generator is written to persistent storage. The unique identifier is capable of being generated using the version written to storage even if newer generators are added at a later time. A unique identifier serves several purposes, among them: preventing access to the customer network, preventing access to the cloud network 104, preventing theft of customer resources, preventing theft of service, and making cloning prohibitively expensive, to name a few non-limiting examples.

The cloud 104 may comprise a collection of products and web services hosted in the cloud 104, such as Interactive Intelligence's PureCloud^{SM} and Amazon Web Services^{SM}, for example. Means for communicating with the device 102, such as a syncing manager, reside in the cloud 104, to which the device's syncing client establishes a connection.

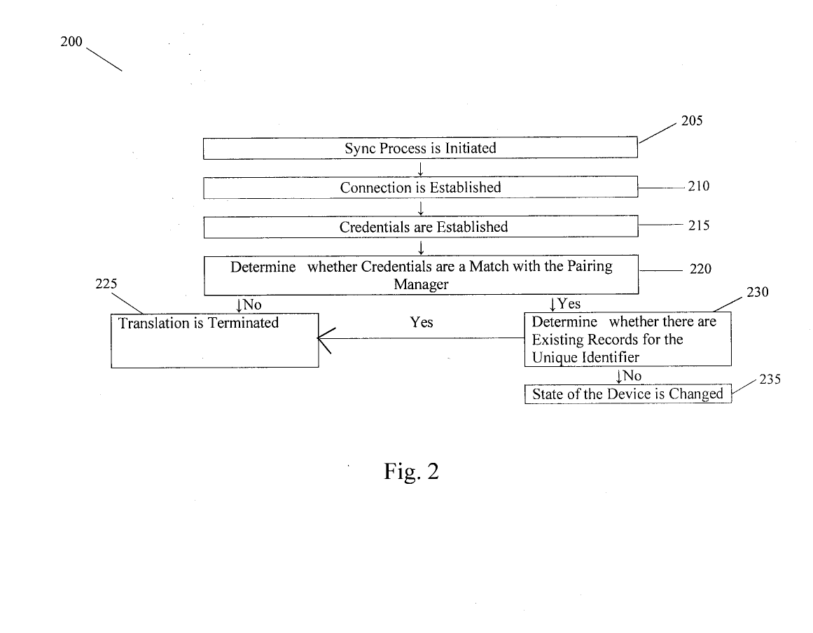

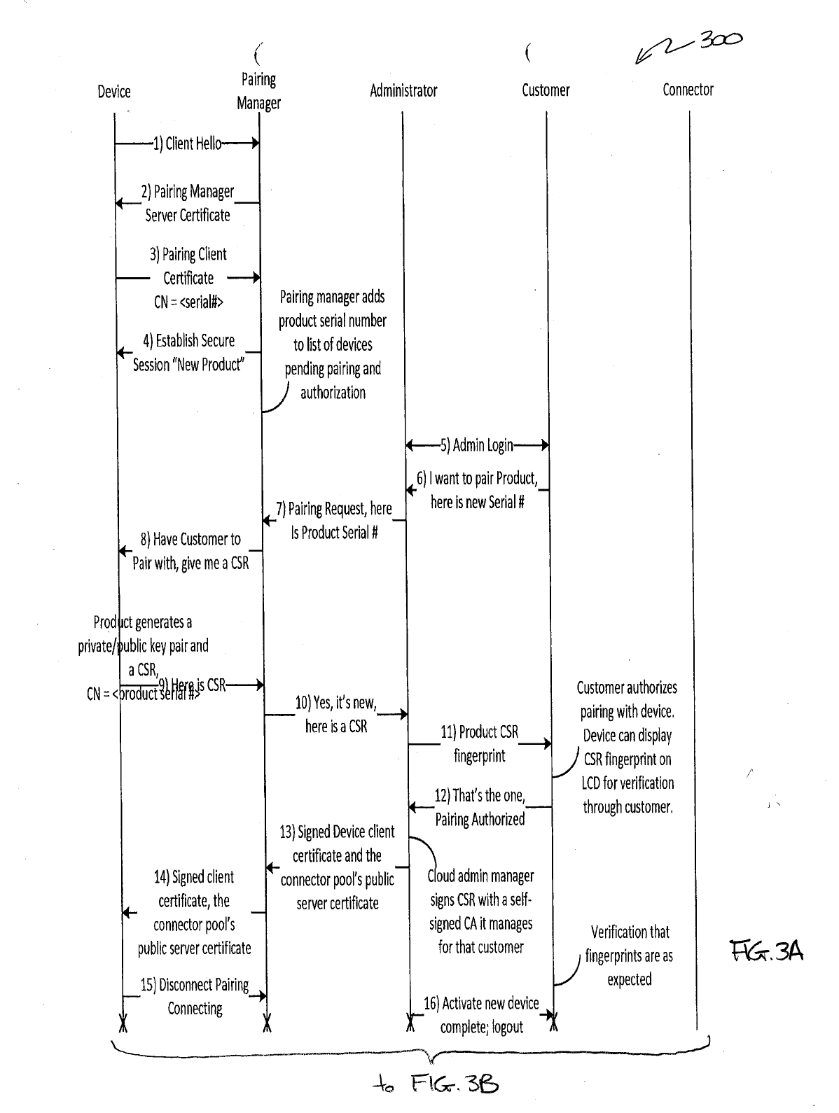

FIG. 2 is a flowchart illustrating a process for device pairing, indicated generally at 200. In an embodiment, the generic provisioning mechanism may be used when a device is distributed to a third party over an untrusted distribution channel. The provisioning mechanism allows a server to recognize and trust the device. For example, a device may need to be paired to web services hosted in the cloud. The device, which has been delivered to a customer, may be on-premises, such as at a customer site or a data center. In order to avoid use by an unauthorized party, the device may have been shipped in an un-provisioned state. As a result, the customer will have to sync (or pair) the device to the cloud products hosted in the cloud in order to have full functionality. In an embodiment, the process for device pairing may only need to be completed once, upon initial start-up of the device.

In operation 205, the sync process is initiated. For example, this may be automatically triggered through powering on the device at the consumer site. Control is passed to operation 210 and process 200 continues.

In operation 210, a connection is established. For example, the device establishes a connection with the cloud. In an embodiment, the device may connect via a pairing client in the device to the pairing manager in the cloud. Control is passed to operation 215 and process 200 continues.

In operation 215, credentials are established. For example, a suite of credentials may be established for the device to connect and operate with the cloud. In an embodiment, this process only needs to be completed once upon initial start-up of the device. Control is passed to operation 220 and process 200 continues.

In operation 220, it is determined if the credentials are a match with the pairing manager. If it is determined that the credentials are not a match with the pairing manager, control is passed to operation 225 and process 200 continues. If it is determined that the credentials are a match with the pairing manager, control is passed to operation 230 and process 200 continues.

The determination in operation 220 may be based on any suitable criteria. For example, the pairing client certificate may use the same ID as the Edge Connection certificate based upon the unique identifier (or “HW_ID”). The cloud system may create a unique Edge_ID for each device HW_ID. In some embodiments, a cryptographic hash function, such as a 256 bit Secure Hash Algorithm (SHA256), may be applied to the unique identifier. Thus, for example, the pairing client certificate may use the ID “SHA256(HW_ID) and the Edge Connection certificate may likewise use the SHA256(HW_ID II Edge_ID). The Edge Connection certificate cannot comprise pairing credentials as they are a one way calculation. The pairing client certificate likewise cannot compromise the HW_ID.

From the HW_ID, a pairing ID may be derived by computing the SHA256(HW_ID II “PAIRING_ID”) in an embodiment. The lower 96-bits are encoded as a PAIRING_ID ASCII string. The string may be a base-25 character set. The HW_ID itself is not visible to the human eye in the certificate file on the disk or the file that is exchanged during the Mutual Transport Layer Security (MTLS) handshake. Instead, the pairing client certificate common name (CN) contains a SHA256(HW_ID) rather than the HW_ID. The pairing client certificate CN is used as the SSL client certificate when communication with the pairing manager in the cloud. The device is capable of recreating the HW_ID from the hardware. The HW_ID is received in the encrypted POST body by the cloud. The cloud then calculates the SHA256(HW_ID) for certificate validation and the SHA256(HW_ID II “PAIRING_ID”) to compute the pairing ID. The pairing client is configured to only trust the pairing manager public certificate and will only establish a MTLS connection with the pairing server.

The pairing client certificate and the pairing server certificate may have an expiration in some embodiments, such as 5 yrs. A 4096 bit key pair may be used to provide a higher level of security during pairing.

It should be noted that the HW_ID is not stored in plain text locally on either the device or in the cloud. Only hashes can be persisted. The HW_ID is only sent to the cloud through TLS connections and only during the pairing process, including set up and connection authentication with the device provider.

If it was determined at operation 220 that the credentials are not a match with the pairing manager, then at operation 225 the transaction is terminated and the process 200 ends. In an embodiment, alerts may also be generated that the transaction has failed. For example, the cloud operator may be notified that a security alert has occurred. An assumption in the product suite may be made that the device pairing certificate has been hijacked in the event of such a failure.

In operation 230 it is determined whether there are existing records for the unique identifier. If it is determined that there are existing records, control is passed to operation 225 and process 200 continues. If it is determined that there are not existing records, control is passed to operation 235 and process 200 continues.

The determination in operation 230 may be based on any suitable criteria. For example, records may indicate that the determined unique identifier has already successfully completed the syncing process. An existing paired unique identifier may indicate that attempts have been made, or are being made, to hijack the device. A lack of an existing paired unique identifier may indicate that pairing has not yet been completed.

In operation 235, the state of the device is changed. For example, the state of the device will no longer be in a state of sync, but may be recognized in the system as a “synced” or “paired” upon successful completion. In an embodiment, the state may be reverted to the syncing state by channel ready solutions in the event that the device is returned and/or repaired.

The state of the HW_ID may be maintained in a database by the cloud. It should be noted that in an embodiment the HW_ID itself is not stored in the database, but rather the SHA256(HW_ID). This prevents compromising of the HW_IDs themselves in the event the database is compromised. A log of any requests may also be kept by the cloud to pair with an unknown HW_ID or a bad pairing client certificate. Information may be kept, such as the client IP, the presented certificate, etc., and an alert may be raised to the cloud operator that security may be compromised. Different states may be defined as:

New: A device has not attempted to pair with the cloud previously. The HW_ID state was built by channel ready solutions and given to the cloud through an Out-of-band authentication (OOBA) transaction.

Paired: A device is attempting to pair with the cloud. An Edge_ID has been generated but pairing has not yet been finalized. Pairing may be repeated on error.

Paired: A device has successfully paired. Any attempts to pair with this HW_ID may be recognized as an attempted security breach.

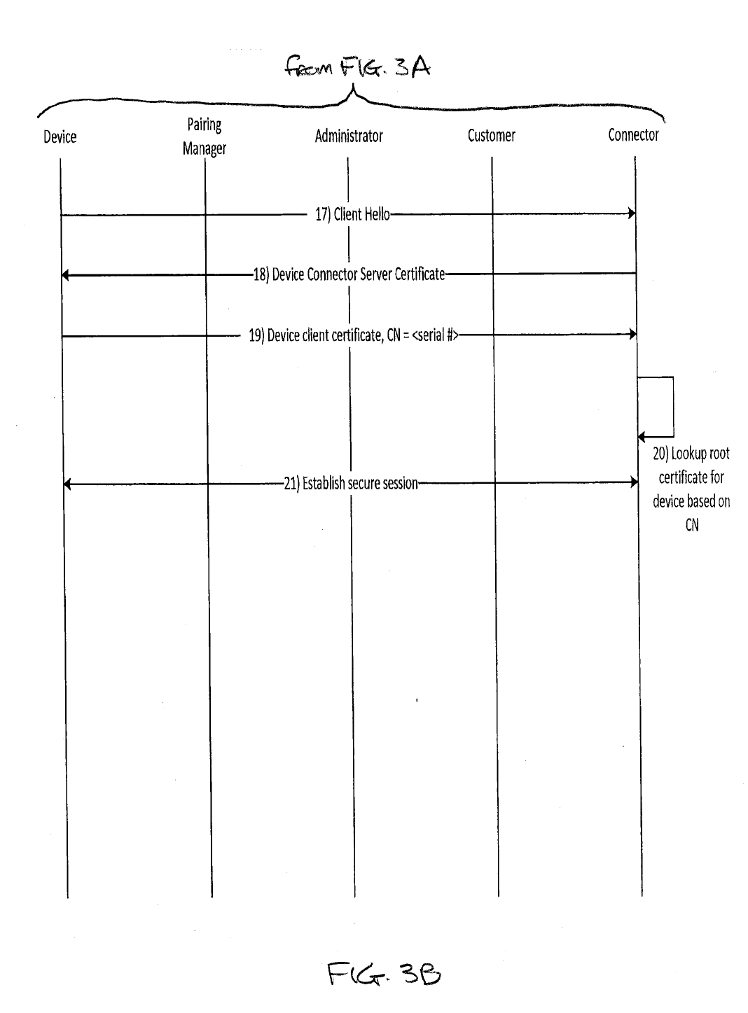

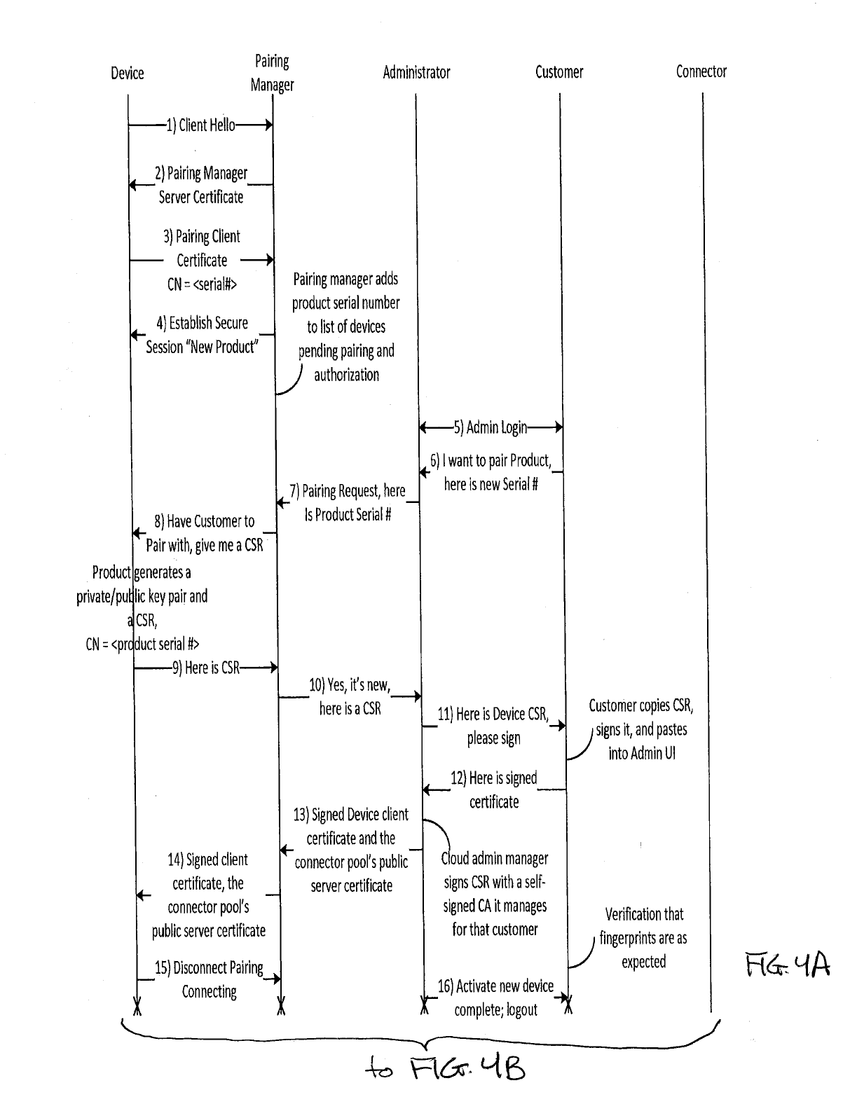

FIGS. 3A-B comprise a sequence diagram illustrating one embodiment of a process for device pairing, indicated generally at 300. The device initiates communication with the pairing manager in the cloud (step 1). The pairing manager sends its server certificate back to the device (step 2). The device then sends its pairing client certificate CN to the pairing manager (step 3). The CN comprises the serial number of the device in an embodiment. The Pairing Manager will establish a secure session with the device as a “new product” (step 4). The pairing manager will also add product serial number to a list of devices pending pairing and authorization. A person with administrative privileges will be logged into the system (step 5). The Customer may indicate that they want to pair a product, and provide the new Serial number to the administrator (step 6). The administrator sends a pairing request to the pairing manager, with the product serial number (step 7). The pairing manager then requests the device to ask the customer for a CSR (step 8). The product generates a private/public key pair and a CSR. The CSR is presented to the pairing manager (step 9). The pairing manager verifies to the administrator that the CSR is new and presents it to the administrator (step 10). The administrator provides a product CSR fingerprint to the customer (step 11), who then authorizes pairing with the device. The device can display the CSR fingerprint on a display for verification through the customer. The customer confirms that the fingerprints are as expected and authorizes the administrator for pairing (step 12). A cloud administrator may sign the CSR with a self-signed CA that it manages for that customer. The administrator provides a signed device client certificate and the connector pool's public server certificate to the pairing manager (step 13). The pairing manager then provides this information to the device (step 14). The pairing connection is disconnected (step 15). If the administrator is finished with device activations, the administrator may mark the new device complete and logout (step 16). The device communicates with the connector (step 17), which then provides the device with the connector server certificate (step 18). The device provides the client certificate CN to the connector (step 19) and the connector provides a lookup for the root certificate for the device based on the CN (step 20). A secure session is then established between the device and the connector (step 21).

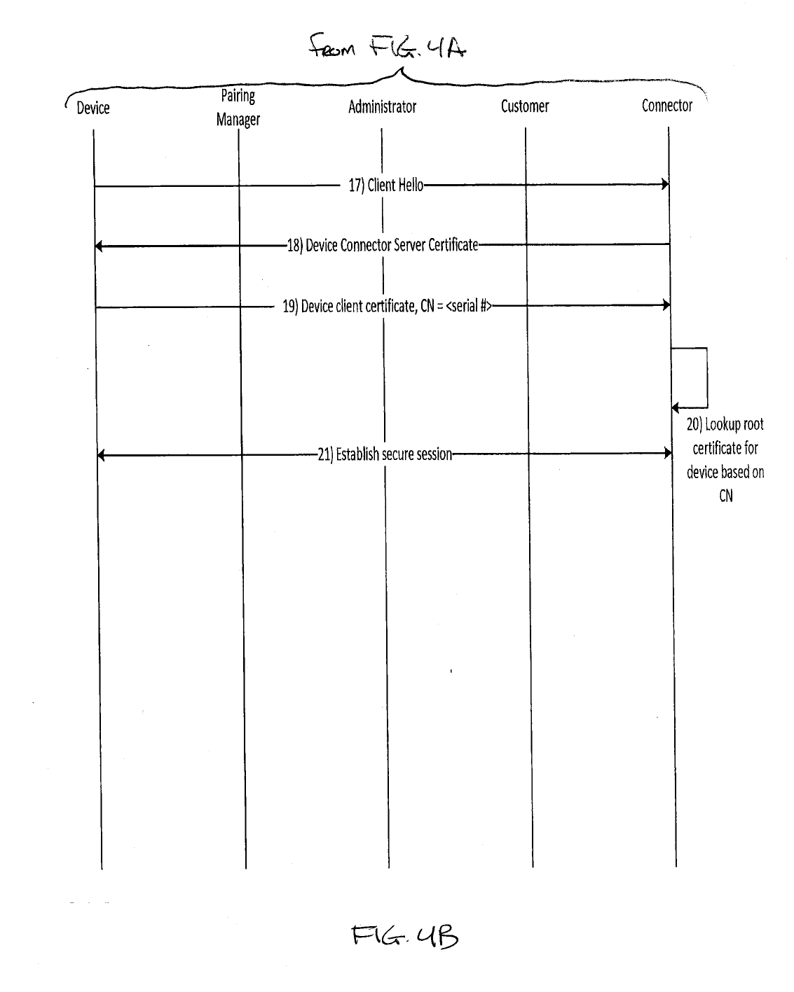

FIGS. 4A-B comprise a sequence diagram illustrating a process for device pairing, indicated generally at 400. The process in FIG. 4 is similar to that of FIG. 3, with the exception of steps 11 and 12. In this scenario, the customer has their own account, where they are provided with the device CSR for signing (step 11). The customer may then copy the CSR, sign it, and paste it into the administrator user interface (step 12).

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the invention as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

1. A method for pairing a device to cloud hosted web services, the method comprising the steps of:
a. initiating the pairing process, comprising the steps of:
i. powering-on the device, wherein the device automatically starts the pairing process;
ii. generating a unique ID using a salt file and manufacture data;
b. establishing a connection between the device and a pairing manager located in the cloud;
c. Establishing credentials of the device
i. The unique ID is sent to cloud, where a check is performed for a match. If no match, transaction terminated and security alert generated. If a match, verify that the device has not been paired before. If it has, terminate request and send security alert.
d. Change a state of the device
i. State change from pairing to run-time with successful completion.

2. The method of claim 1, wherein the device is located remotely from the cloud.

3. The method of claim 1, wherein the device is in an un-provisioned, un-synced state prior to step (a), but has been pre-configured to initiate the syncing process.

4. The method of claim 1, wherein step (b) comprises establishing a MTLS connection between the device and the pairing manager.
